(19) United States
(12) Patent Application Publication
(10) Pub. No.: US 2024/0173858 A1
(43) Pub. Date: May 30, 2024

(54) Force-Controlled Handling Apparatus for Robot-Assisted Surface Machining

(71) Applicant: FerRobotics Compliant Robot Technology GmbH, Linz (AT)

(72) Inventor: Ronald Naderer, Linz (AT)

(21) Appl. No.: 18/283,616

(22) PCT Filed: Mar. 22, 2022
(86) PCT No.: PCT/EP2022/057458

§ 371 Date: Sep. 22, 2023

(30) Foreign Application Priority Data
Mar. 22, 2021 (DE) 10 2021 106 990.4

(51) Int. Cl. B25J 9/16; B25J 11/00; B25J 13/08

(52) U.S. Cl. CPC B25J 9/1633; B25J 11/005; B25J 13/085

(57) ABSTRACT

An embodiment relates to a handling apparatus with a linear actuator acting between a first flange connectable to a manipulator and a second flange to which a tool, or a machine tool with a tool, can be mounted. The linear actuator exerts a force on the second flange, or an end stop, in accordance with a control variable. The device further comprises a force sensor coupled between the second flange and the tool and configured to measure a force exerted by the handling apparatus on the tool upon contact between the tool and a surface. A control unit comprises a state observer configured to determine an estimated value for the force exerted by the handling apparatus on the tool based on the control variable. The control unit is further adapted to detect a contact between the tool and the surface, wherein the control variable is adjusted based on the estimated value and a target value as long as no contact is detected, whereas the control variable is adjusted based on the measured force and the target value as long as a contact is detected.

### TECHNICAL FIELD

The present disclosure relates to a force-controlled handling apparatus for automated, robot-assisted surface machining. Such handling apparatus can in particular serve as an interface between manipulator (robot) and machine tool.

### BACKGROUND

In robotic surface finishing, a machine tool (e.g., a grinding machine, a drilling machine, a milling machine, a polishing machine, and the like) is guided by a manipulator, such as an industrial robot. Thereby, the machine tool may be coupled in various ways to the so-called TCP (Tool Center Point) of the manipulator; the manipulator can usually adjust, practically arbitrarily, the position and orientation of the TCP in order to move a machine tool along a trajectory e.g. parallel to a surface of a workpiece. Industrial robots are usually position controlled, which allows precise movement of the TCP along the desired trajectory.

In order to achieve a good result in robot-assisted grinding, polishing or other surface machining processes, many applications require control of the process force (e.g. grinding force), which is often difficult to achieve with sufficient accuracy using conventional industrial robots. The large and heavy arm segments of an industrial robot have too much inertia for a closed-loop controller to react quickly enough to variations of the process force. To solve this problem, a small (and lightweight) handling apparatus can be placed between the manipulator TCP and the machine tool to couple the manipulator TCP to the machine tool. In particular, the handling apparatus comprises a linear actuator and only controls the process force (i.e., the contact force between the tool and the workpiece) during surface machining, while the manipulator moves the machine tool together with the linear actuator along the desired trajectory in a position-controlled manner.

In many surface finishing processes, the quality of the machining result is strongly dependent on whether the process force remains within a desired, specified range during the machining process. For example, in a grinding process, a grinding force (process force) that is too high (even for a short time) can severely damage or even destroy the workpiece and/or cause high repair costs.

The inventor has set himself the objective of developing an improved handling apparatus with force control, which makes it possible to largely ensure compliance with the specified process force.

### SUMMARY

One embodiment relates to a handling apparatus with a linear actuator, which acts between a first flange, which is connectable to a manipulator, and a second flange, on which a tool or a machine tool with a tool can be mounted. The linear actuator exerts a force onto the second flange or an end stop in accordance with a control variable. The device further comprises a force sensor coupled between the second flange and the tool and configured to measure a force exerted by the handling apparatus onto the tool while the tool contacts a surface. A control unit has a state observer that is designed to determine an estimated value for the force exerted by the handling apparatus onto the tool based on the control variable. The control unit is further configured to detect a contact between the tool and the surface, wherein the control variable is determined based on the estimated value and a target value as long as no contact is detected, whereas the control variable is adjusted based on the measured force and the target value (setpoint) as long as contact is detected.

Another embodiment relates to a method for controlling a handling apparatus, which comprises a linear actuator that acts between a first flange connectable to a manipulator and a second flange, to which a tool or a machine tool with a tool can be mounted. According to an embodiment, the method comprises controlling the linear actuator with a control variable such that the linear actuator exerts a force on the second flange or an end stop in accordance with the control variable. The method further comprises detecting a contact between the tool and the end stop and measuring—in the case of contact between the tool and a surface—a force exerted by the handling apparatus on the tool by means of a force sensor coupled between the second flange and the tool. Furthermore, an estimate of the force exerted by the handling apparatus onto the tool is determined based on the control variable. As long as no contact is detected, the control variable is determined based on the estimated value and a target value, and as long as a contact is detected, the control variable is adjusted based on the measured force and the target value.

### BRIEF DESCRIPTION OF THE DRAWINGS

Various implementations are explained in more detail below with reference to the examples shown in the figures. The illustrations are not necessarily to scale and the embodiments are not limited to the illustrated aspects. Rather, emphasis is placed on illustrating the underlying principles of the illustrated embodiments.

FIG. 1 is a general example of a system for robotic grinding comprising an industrial robot, a handling apparatus with force control, and a grinding machine.

FIG. 2 illustrates an example implementation of the handling apparatus (without the associated control unit).

FIG. 3 illustrates an example of a control unit for the handling apparatus in which the force control is implemented.

FIG. 4 illustrates an example of a method for controlling a handling apparatus for robotic surface machining.

### DETAILED DESCRIPTION

Before various embodiments are explained in detail, a general example of a robot-assisted grinding device will first be described. It is understood that the concepts described herein are not limited to grinding and are also applicable to other types of surface machining (e.g., polishing, milling, drilling, etc.).

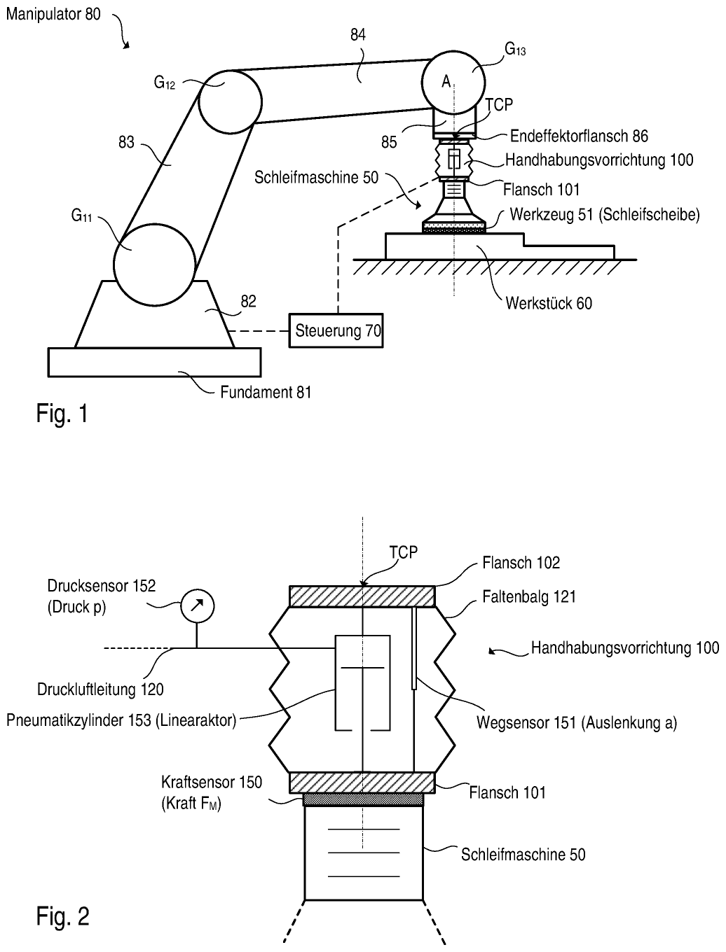

According to FIG. 1, a robot-assisted grinding device comprises a manipulator 80, for example an industrial robot, and a grinding machine 50 with a rotating grinding tool 51. The grinding machine 50 is coupled to the so-called tool center point (TCP) of the manipulator 80 via a linear actuator 100, which is generally referred to as a handling apparatus. Strictly speaking, the TCP is not a point but a vector and can be described, for example, by three spatial coordinates (position) and three angles (orientation). In robotics, generalized coordinates (usually six joint angles of the robot) in configuration space are sometimes used to describe the position of the TCP. Position and orientation of the TCP are sometimes also referred to as “pose”. The position (including orientation) of the TCP as a function of time defines the motion of the grinding tool, which is called the trajectory. The TCP is often defined as the center of the end effector flange of the robot, but this is not necessarily the case. The TCP can be any point (and theoretically can be outside the robot) whose position and orientation is adjustable by the robot. The TCP can also define the origin of the tool coordinate system.

In the case of an industrial robot with six degrees of freedom, the manipulator 80 may be composed of four segments 82, 83, 84 and 85, each connected by joints G11, G12 and G13, respectively. The first segment 82 is usually rigidly connected to a base 81 (although this need not necessarily be the case). The joint G11 connects the segments 82 and 83. The joint G11 can be 2-axis and allow a rotation of the segment 83 around a horizontal rotation axis (elevation angle) and a vertical rotation axis (azimuth angle). The joint G12 connects the segments 83 and 84 and allows a pivoting movement of the segment 84 relative to the position of the segment 83. The joint G13 connects the segments 84 and 85. The joint G13 can be 2-axial and therefore (similar to the joint G11) allows a pivoting movement in two directions. The TCP has a fixed relative position to the segment 85, whereby the latter usually also comprises a rotary joint (not shown), which enables a rotational movement of the end effector flange 86 arranged on the segment 85 about a longitudinal axis A of the segment 85 (drawn as a dashed line in FIG. 1, also corresponds to the rotational axis of the grinding tool in the example shown). Each axis of a joint is associated with an actuator (e.g., an electric motor) which can cause a rotary movement about the respective joint axis. The actuators in the joints are controlled by a robot controller 70 according to a robot program. Various industrial robots/manipulators and associated controllers are known per se and are therefore not explained further herein.

The manipulator 80 is typically position controlled, i.e. the robot controller can determine the pose (position and orientation) of the TCP and move it along a predefined trajectory. In FIG. 1, the longitudinal axis of the segment 85, on which the TCP is located, is labeled A. When the linear actuator of the handling apparatus 100 rests against an end stop, the pose of the TCP also defines the pose of the grinding machine 50 (and also of the grinding wheel 51). As mentioned at the beginning, the handling apparatus 100 is used to adjust the contact force (process force) between the tool (e.g., grinding wheel 51) and the workpiece 60 to a desired value during the grinding process. Direct force control by the manipulator 80 is generally too inaccurate for grinding applications, because due to the high inertia of the segments 83 to 85 of the manipulator 80 a rapid compensation of force peaks (e.g., when the grinding tool is placed on the workpiece 60) is practically impossible with conventional manipulators. For this reason, the robot controller 70 is designed to control the pose (position and orientation) of the TCP of the manipulator 80, while the force control is performed exclusively by means of the handling apparatus 100.

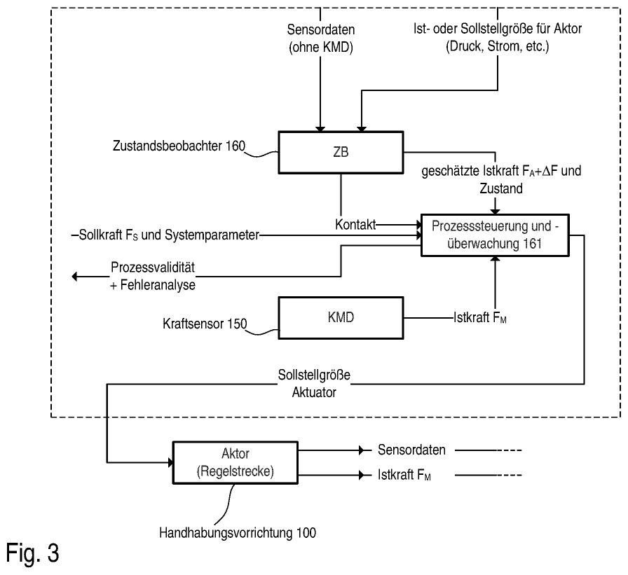

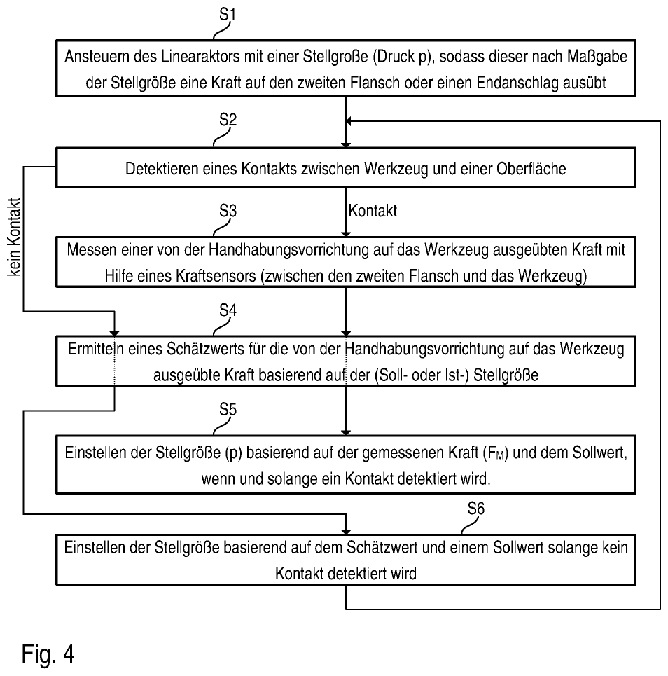

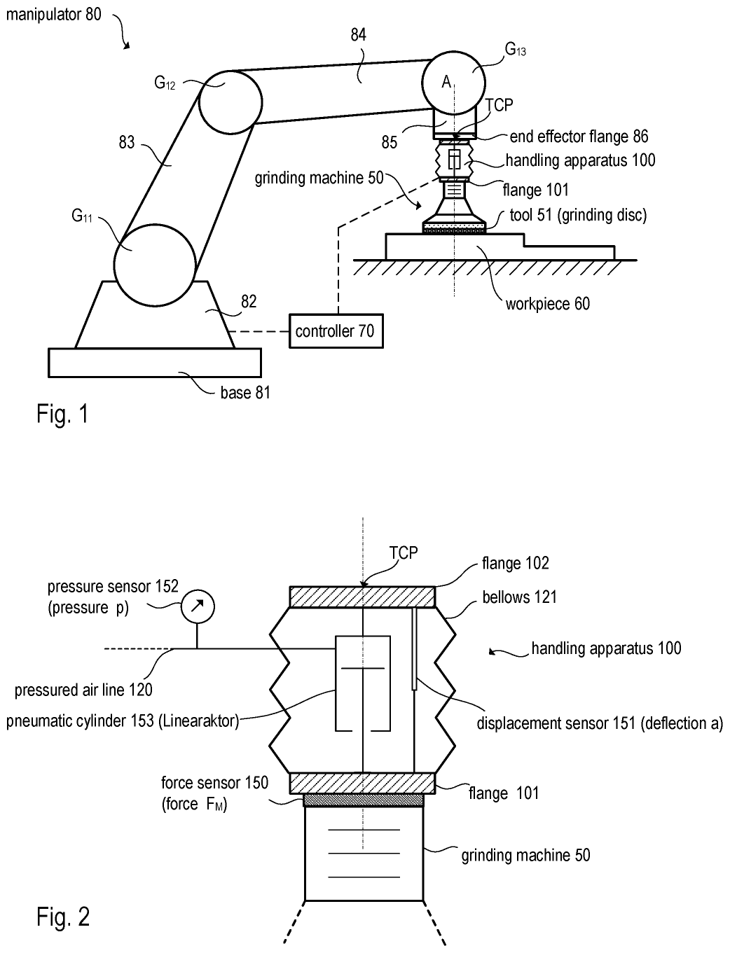

As already mentioned, during the grinding process, the contact force F_{K} between the grinding tool (grinding wheel 51 of the grinding machine 50) and the workpiece 60 can be adjusted with the help of the handling apparatus 100 and a force control (which can be implemented in the controller 70, for example) in such a way that the contact force F_{K} (in the direction of the longitudinal axis A) between the grinding wheel 51 and the workpiece 60 corresponds to a predeterminable setpoint value. The contact force F_{K} is a reaction to the actuator force F_{A} with which the handling apparatus 100 presses onto the workpiece surface. If there is no contact between the workpiece 60 and the tool 51, the actuator included in the handling apparatus 100 (see also FIG. 2) moves against an end stop (not shown because integrated in the actuator 2) due to the lack of contact force onto the workpiece 60, and presses against it with a defined force. The force control is active throughout. In this situation (no contact), the actuator deflection is therefore at its maximum and the handling apparatus is in an end position. The defined force with which the (linear) actuator (which is included in the handling apparatus 100) presses against the end stop can be very small or (theoretically) even controlled to zero in order to enable the smoothest possible contact with the workpiece surface.

The position control of the manipulator 80 (which may also be implemented in the controller 70) may operate completely independently of the force control of the handling apparatus 100. The latter is not responsible for the positioning of the grinding machine 50, but only for setting and maintaining the desired contact force F_{K} during the grinding process and for detecting contact between the tool 51 and the workpiece 60. Contact can be detected in a simple manner, for example, by the fact that the linear actuator included in the handling apparatus moves out of the end position (actuator deflection a is smaller than the maximum deflection a_{MAX} at the end stop).

In FIG. 2, an example of the handling apparatus 100 is shown schematically. Parts that are known to one skilled in the art and are not necessary for the following discussion (such as valves, linear guides, etc.) have been omitted from FIG. 2 so as to not complicate the illustration. The actuator 153 included in the handling apparatus 100 may be a pneumatic actuator, such as a double-acting pneumatic cylinder. However, other pneumatic actuators are also applicable such as bellows cylinders and air muscles. Alternatively, direct electric actuators (gearless) may also be considered.

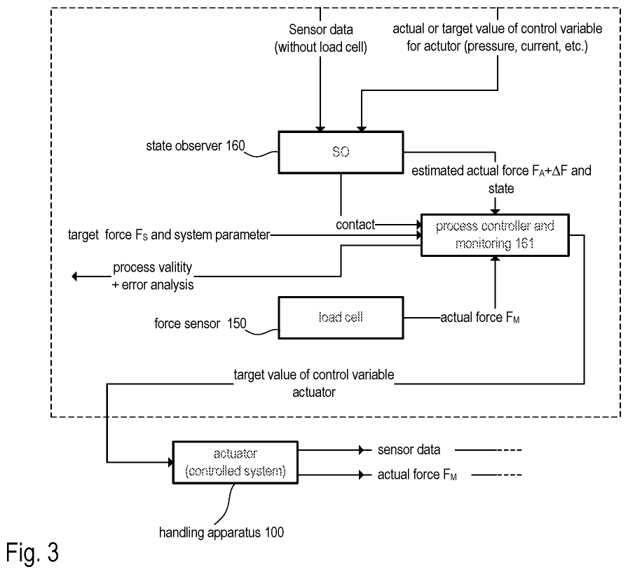

It is understood that the direction of action of the actuator/handling apparatus 100 and the axis of rotation of the grinding machine 50 do not necessarily have to coincide with the longitudinal axis A of the segment 85 of the manipulator 80. In the case of a pneumatic actuator, the force control may be implemented in a manner known per se with the help of a control valve, a controller (e.g., implemented in the control unit 70) and a compressed air reservoir or a compressor. Since the inclination with respect to the perpendicular is relevant for considering gravity (i.e., the weight force of the grinder 50), the actuator 2 may include an inclination sensor (not shown) or this information may be determined based on the joint angles of the manipulator 80. The determined inclination is taken into account by the force controller (see also explanations associated with FIG. 3). The handling apparatus 100 not only provides a degree of mechanical decoupling between the manipulator 80 and the workpiece 60 but is also capable of compensating for inaccuracies in the positioning of the TCP.

In addition to the linear actuator 153 (pneumatic cylinder), the handling apparatus comprises a displacement sensor, which may be designed, for example, as an inductive sensor or as a potentiometer. In essence, the displacement sensor is designed to measure the displacement of the linear actuator 153. At a maximum displacement a=a_{MAX}, the linear actuator presses against an end stop. The linear actuator may couple the two flanges 101 and 102. The change of the distance between the two flanges 101 and 102 corresponds to the change of the deflection of the linear actuator 153. The upper flange 102 (see FIG. 2) may be connected (e.g., by means of screws) to the end effector flange of a robot (see FIG. 1, end effector flange 86). The machine tool 50 may be mounted (directly or indirectly) on the lower flange 101, whereby in the depicted example a force sensor 150 is arranged between the handling apparatus and the machine tool 50. This force sensor 150 may be designed, for example, as a load cell and enables direct measurement of the force acting between the handling apparatus and the machine tool 50.

A bellows 121 can protect the parts within the handling apparatus against dust and the like, while allowing movement in the direction of action of the pneumatic cylinder 153. In this regard, the bellows 121 acts as a spring whose characteristic can be taken into account in the force control. The (spring) force component caused by the bellows 121 may be determined, for example, based on the deflection a measured by the distance sensor 151. In the simplest case, the (spring) force component caused by the bellows 121 is proportional to the deflection (if the spring characteristic is linear). In some embodiments, the actual spring characteristic of the bellows 121 is determined by means of calibration measurements.

In addition to the direct force measurement by the load cell 150, an indirect force measurement is performed by measuring the pressure p in the pneumatic cylinder 153 using a pressure sensor 152, which may be pneumatically coupled to a compressed air line of the pneumatic cylinder 153. The force is then obtained by multiplying the pressure p by the piston area A effective in the cylinder (F_{A}=p·A). If an electromechanical actuator is used instead of a pneumatic actuator, the force can also be determined from the current consumption of the electromechanical actuator. Instead of a pressure measurement, a current measurement is performed in this case. The actuator force can then be calculated from the measured current value.

In known systems, a redundant force measurement by a direct force sensor such as a load cell is usually not provided, since in controlled pneumatic systems the cylinder pressure (or in electromechanical actuators the current) is provided as measured value anyway. In this context, it is important to mention that in the example described herein, the direct force measurement (force F_{M}) by the force sensor 150 does not simply provide a redundant measured value to the indirect force measurement (force p·A). If one wanted to replace the indirect force measurement (by means of pressure or current measurement) by a direct force measurement by means of a load cell, then the respective force sensor would have to be arranged in such a way that it measures the actuator force exerted by the actuator (pneumatic cylinder) onto the flange 101 of the handling apparatus 100. In this case, when the movement of the flange 101 (relative to the flange 102) is blocked, for example by an end stop, the force sensor would measure the actuator force acting against the end stop, even if there is no contact with the workpiece. However, this is not the case in the example shown in FIG. 2. The force sensor 150 is not inside the handling apparatus 100 (between the pneumatic cylinder 153 and the flange 101), but on the outside of the flange 101, so that the force sensor only measures the force F_{M} acting between the machine tool 50 and the handling apparatus. In the absence of contact with the workpiece, the force sensor 150 in the depicted example would only measure the weight force of the machine tool 50, regardless of whether and with what force F_{A} the pneumatic cylinder 153 presses against the end stop. This means that in the examples described herein—in the absence of contact—the direct force measurement (force F_{M}) and the indirect force measurement (force p·A) are not redundant, but fundamentally different forces are measured.

A connection between the actuator force F_{A} (F_{A}=p·A in the case of a pnaumatic cylinder) determined by indirect force measurement and the directly measured force F_{M} can only be formulated if there is contact between the workpiece and the machine tool. Only in this situation (contact present) does a contact force F_{K} (process force) act back on the handling apparatus and F_{K}=F_{M}+F_{G} applies, wherein F_{G} denotes the weight force of the machine tool acting on the workpiece surface and F_{M} the directly measured force with which the handling apparatus presses onto the machine tool. At this point it should be noted that the weight force F_{G} can also become negative if the grinding machine is operated upside down. In the case of contact F_{M}=F_{A}+ΔF=p·A+ΔF applies for the directly measured force F_{M}, wherein the offset ΔF includes all disturbing forces (e.g., friction, hysteresis effects, etc.). For the contact force/process force, F_{K}=F_{A}+F_{G}+ΔF=F_{M}+F_{G} thus applies for contact, whereby the offset ΔF, which depends on the condition of the handling apparatus, can be determined during operation (e.g. based on mathematical models and/or calibration measurements).

The block diagram in FIG. 3 shows an example of a control unit that can be used to operate the handling apparatus 100. The control unit of FIG. 3 comprises a state observer 160, also called state estimator, which is supplied with the setpoint or the control variable, which in the present example represents the desired value or, respectively, the measured actual value of the cylinder pressure. The state observer 160 further receives sensor data (e.g., the measured deflection a of the handling apparatus 100, the acceleration of the handling apparatus, the inclination of the handling apparatus to the perpendicular, etc.) as well as system parameters (e.g. the weight of the machine tool mounted on the handling apparatus) and is designed to estimate a state of the handling apparatus from the supplied information (sensor data and control variable), in particular the effective force F_{A}+ΔF (estimated actual process force) provided by the actuator (pneumatic cylinder) which acts either on the end stop (in the absence of contact) or on the workpiece (in case of contact). For the state estimation, the state observer can include mathematical models that model the physical behavior of the handling apparatus (e.g. spring characteristic of the bellows, friction, etc.).

The state observer 160 is further configured to detect and signal a contact between the machine tool and the workpiece. Since in the absence of contact the actuator (pneumatic cylinder) presses against its end stop, contact can be detected, for example, solely by detecting that the actuator moves away from the end stop (i.e., deflection a is smaller than the maximum deflection a_{MAX} at the end stop).

Another component of the control unit of FIG. 3 is the process controller and monitoring unit 161. This is where the control (regulation) of the process force takes place. For this purpose, the process controller and monitoring unit 161 receives the estimated actual process force and information regarding contact from the state observer 160 as well as system parameters (e.g. weight of the machine tool 50), the target process force F_{S} and the actual process force F_{M} measured directly by the force sensor 150, which, as discussed above, is only a useful measure if contact is present. Based on the target process force F_{S} and the directly measured and/or estimated actual force F_{M} or F_{A}+ΔF, and taking into account the weight force F_{G}, a control algorithm is used to calculate the control variable, with which the actuator is controlled (in the case of a pneumatic actuator, as mentioned, this is the cylinder pressure p). Suitable control algorithms are known per se and will therefore not be discussed further herein. With a theoretical control error (control deviation) of zero, the control variable (e.g. a pressure for pneumatic actuators, an actuator current for electromechanical actuators) is adjusted in such a way that, at contact, the following applies for the process force F_{K}: F_{K}=F_{M}+F_{G}=F_{S}. This means that the process force (contact force) corresponds to the (possibly varying) target force.

The process control and monitoring unit 161 is further adapted to select the “source” for the actual process force (i.e., either the force sensor 150 or the state observer 160) depending on whether contact has been detected or not. If no contact is detected, the state observer 160 is selected, and if contact is detected, the force sensor 150 is selected. Ideally, both sources should provide the same force value—if contact is detected—but the estimated value F_{A}+ΔF includes certain influence parameters determined by calibration. The directly measured value F_{M}, on the other hand, always measures the actual force (provided that the force sensor 150 functions properly).

Plausibility check: The process controller and monitoring unit 161 may be further configured to perform a plausibility check during a surface machining process (i.e., upon contact) based on the directly measured force value F_{M} and the force value F_{A}+ΔF provided by the state observer. For this purpose, the process controller and monitoring unit 161 can compare the two values F_{A}+ΔF and F_{M}, and in case of discrepancies, for example, report an error. In some situations, it is even possible based on the deviation between the two values F_{A}+ΔF and F_{M} and their course over time, and—as the case may be—taking into account other measured values such as the measured deflection a, to determine a (probable) cause for the deviation. For example, if the directly measured force value F_{M} no longer follows the value estimated by the state observer, a probable cause is that the linear guide in the handling apparatus is jammed or the friction is greatly increased. If the directly measured value F_{M} follows the estimated value F_{A}+ΔF with a smaller deviation, this may indicate that the friction in the pneumatic cylinder (actuator 153) or the linear guide (not shown) is slightly increased and maintenance should be performed.

The following is a summary of some aspects and features of the embodiments described herein. It is understood that the following is not an exhaustive enumeration, but merely an exemplary summary. The embodiments relate to a system and method for controlling a handling apparatus having a first flange and a second flange, and having a linear actuator acting between the first flange and the second flange. In operation, the first flange is mounted to a manipulator (e.g., to its end effector flange, see FIG. 1), and in operation, a tool (or a machine tool with a tool) is mounted to the second flange. The linear actuator can exert a force on the second flange in accordance with a control variable while it is supported on the first flange (cf. FIG. 2, flanges 101 and 102, linear actuator 152). In the case of a pneumatic actuator (pneumatic cylinder), the control variable is an air pressure; in the case of an electromechanical actuator, the control variable may be the current flowing through the actuator.

In one embodiment, a force sensor is disposed between the second flange and the tool such that the force sensor measures a force F_{M} exerted by the handling apparatus on the tool upon contact between the tool and a surface. The contact force between the tool and the surface corresponds to a superposition of the force F_{M} and the weight force F_{G} (which depends on the angular position) exerted by the weight of the machine tool and the tool on the surface.

Without contact, the machine tool hangs on the handling apparatus and the force sensor only measures its weight force F_{G}, while the linear actuator (force-controlled) presses against an end stop. In this situation, the mentioned force sensor cannot be used for force control. Therefore, a state observer, which can be implemented e.g. in a control unit, is used to determine an estimated value for the force F_{A}+ΔF provided by the linear actuator based on the control variable (e.g. pressure setpoint or actual pressure). The control unit may also be configured to detect a contact between the tool and a surface. Furthermore, the control unit is designed to set the control variable (e.g. pressure p) for the linear actuator based on the estimated value F_{A}+ΔF and a setpoint value when no contact is detected, and to adjust the control variable based on the measured force F_{M} and the setpoint value when (as soon as and as long as) a contact is detected. That is, the force information used for force control depends on whether a contact is detected or not.

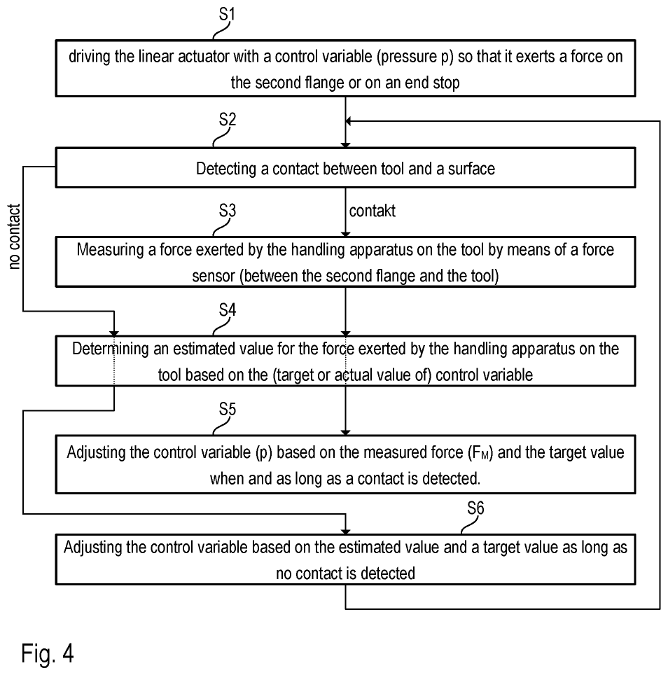

An example of the concept described herein is summarized below with reference to the flowchart of FIG. 4. FIG. 4 relates to a method of controlling a handling apparatus having a linear actuator (see FIG. 2, pneumatic cylinder 154) acting between a first flange (see FIG. 1, flange 102) connectable to a manipulator and a second flange (see FIG. 1, flange 101) to which a tool, or a machine tool with a tool, can be mounded. The method comprises controlling the linear actuator with a control variable (e.g. an air pressure p) so that the linear actuator (according to the control variable) exerts a force on the second flange (in case of contact between tool and surface) or on an end stop (in case of no contact) (see FIG. 4, step S1). The method further comprises detecting a contact between tool and surface (see FIG. 4, step S2) and—in case of contact between tool and surface—measuring a force F_{M} exerted by the handling apparatus on the tool by means of a force sensor mechanically coupled between the second flange and the tool (see FIG. 4, step S3).

The method further comprises (with or without contact to the surface) determining an estimated value F_{A}+ΔF for the force F_{M} exerted by the handling apparatus on the tool based on the control variable (see FIG. 4, step S4). The control variable is adjusted based on the estimated value and a target value when and as long as no contact is detected (see FIG. 4, step S6), and based on the measured force and the setpoint value when and as long as a contact is detected (see FIG. 4, step S5). It is understood that the process steps shown in FIG. 4 run partially in parallel. The arrows in the flow diagram do not imply a mandatory chronological order.

In particular, step S4 is executed regardless of whether a contact has been detected or not. In the absence of contact, the estimated value for the force is needed to be able to adjust the force, with which the linear actuator presses on the end stop. For smooth contact, this force should be as small as possible (ideally zero or a few newtons). When the tool touches the surface, the actuator moves away from the end stop and the force control can then be based on the directly measured force F_{M}. Nevertheless, for validation of the process and for error detection, the estimated value F_{A}+ΔF is also determined during the surface machining process (at contact). Before a contact, the actuator presses on the end stop with the smallest possible (minimum) force. Theoretically, this minimum force can be controlled to zero Newtons. In practice, values of less than 10 Newtons or even less than 1 Newton are used in order to be able to contact the surface very gently. Once contact is made, the target force can be increased at a defined rate until the desired process force (grinding force) is reached.

In addition to the control variable (pressure in the case of a pneumatic actuator), further sensor data concerning the state of the actuator and/or the handling apparatus may be included in the determination of the estimated value (cf. FIG. 3, state observer 160), such as the deflection of the actuator, which can be measured, for example, with a potentiometer or an inductive displacement sensor coupled to the actuator. The weight force F_{G}=m·g·cos(θ) may, for example, be taken into account in force control (see FIG. 3, process control 161), for example by subtracting the weight force F_{G} from the nominal force (m denotes the mass of the machine tool including tool, g the acceleration due to gravity and θ the angular deviation from the perpendicular (tilt angle, tilt)). Alternatively, the weight force may also be taken into account in the direct and indirect force measurement. The tilt angle θ may either be measured or calculated from the (generalized) coordinates of the manipulator's TCP. The robot controller “knows” the angular position of the TCP and thus also the angular position of the manipulator and the tool. [

According to an embodiment example, it is also possible to automatically check the process validity of a surface machining process and to confirm it at the end of the process. For this purpose, for example, during a surface machining process the force F_{M} measured (directly by means of a force sensor) and the estimated value F_{A}+ΔF (determined by the state observer) may be compared and any deviations between the measured value and the estimated value for a particular surface machining process may be logged. At the end of the process or already during the process, the logged data may be evaluated to check the validity of the process and/or to indicate errors, if any. For this purpose, for example, specific errors may be determined based on deviations between the directly measured force and the estimated value (and possibly other sensor data such as the actuator deflection). For example, if the measured force does not increase equally when the estimated value increases while there is contact with the surface, then it is very likely that a linear guide (e.g., arranged parallel to the actuator) or the actuator itself is stuck, or at least that the friction in the linear actuator or linear guide is unusually high. In this case, smooth contact can no longer be guaranteed the next time the surface is contacted. In addition or alternatively, deviations between the force setpoint and the measured force may also be evaluated.

Terms such as “first”, “second”, and the like, are used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

It is to be understood that the features of the various embodiments described herein may be combined with each other, unless specifically noted otherwise.

Although various embodiments have been illustrated and described with respect to one or more specific implementations, alterations and/or modifications may be made to the illustrated examples without departing from the spirit and scope of the appended claims. With particular regard to the various functions performed by the above described components or structures (units, assemblies, devices, circuits, systems, etc.), the terms (including a reference to a “means”) used to describe such components are intended to correspond—unless otherwise indicated—to any component or structure that performs the specified function of the described component (e.g., that is functionally equivalent), even if it is not structurally equivalent to the disclosed structure that performs the function in the herein illustrated exemplary implementations of the invention.

It will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1-10. (canceled)

11. A system, comprising:
a handling apparatus having a linear actuator acting between a first flange connectable to a manipulator and a second flange on which a tool, or a machine tool with a tool, can be mounted, wherein the linear actuator is configured to exert a force on the second flange or an end stop in accordance with a control variable;
a force sensor coupled between the second flange and the tool, wherein the force sensor is configured to measure a force exerted by the handling apparatus on the tool upon contact between the tool and a surface;
a control unit including a state observer configured to determine, based on the control variable, an estimated value for the force exerted by the handling apparatus on the tool,
wherein the control unit is further configured to:
detect a contact between the tool and the surface;
adjust the control variable based on the estimated value and a target value, as long as no contact is detected; and
adjust the control variable based on the measured force and the target value as long as a contact is detected.

12. The system of claim 11, wherein the target value is variable and is increased from a minimum value after detection of the contact.

13. The system of claim 11, wherein the linear actuator presses against the end stop as long as no contact is detected.

14. The system of claim 11, wherein the control unit is further configured to compare, as long as contact is detected, the measured force and the estimated value, and to indicate or record an error based on any deviation between the measured force and the estimated value.

15. The system of claim 11, wherein the control unit is further configured to check, as long as contact is detected and a surface machining process is performed, a process validity based on the measured force and the estimated value and, if the check fails, to determine a possible source of error.

16. The system of claim 11, wherein the state observer is designed to determine the estimated value based on the control variable and on further sensor data concerning a state of the linear actuator.

17. The system of claim 16, wherein the state of the linear actuator is the actuator deflection.

18. A method of controlling a handling apparatus having a linear actuator acting between a first flange connectable to a manipulator and a second flange on which a tool, or machine tool with a tool, can be mounted, the method comprising:
controlling the linear actuator with a control variable so that the linear actuator exerts a force on the second flange, or on an end stop, in accordance with the control variable;
detecting contact between the tool and a surface;
measuring, in case of contact between the tool and a surface, a force exerted by the handling apparatus on the tool using a force sensor coupled between the second flange and the tool;
determining an estimated value for the force exerted by the handling apparatus on the tool based on the control variable;
adjusting the control variable based on the estimated value and a target value as long as no contact is detected, and adjusting the control variable based on the measured force and the target value as long as contact is detected.

19. The method of claim 18, wherein further sensor data relating to the state of the linear actuator is taken into account when determining the estimated value.

20. The method of claim 19, wherein the further sensor data relating to the state of the linear actuator is a deflection of the linear actuator.

21. The method of claim 18, wherein contact between the tool and a surface is detected as the linear actuator moves away from the end stop.

22. The method of claim 18, wherein when the tool contacts the surface during a surface machining process, a validity of the surface machining process is checked based on the determined estimated value and further based on the measured force, and in case of deviations between the measured force and the estimated value, a cause of error is determined.
